(19) United States
(12) Patent Application Publication
(10) Pub. No.: US 2006/0229793 A1
(43) Pub. Date: Oct. 12, 2006

(54) Vehicular travel control system

(75) Inventors: Kiichiro Sawamoto, Saitama (JP); Shigeru Inoue, Saitama (JP)

Correspondence Address: BRIAN M BERLINER, ESQ;O'MELVENY & MYERS, LLP, 400 SOUTH HOPE STREET, LOS ANGELES, CA, 90071-2899, US

(73) Assignee: HONDA MOTOR CO., LTD.

(21) Appl. No.: 11/389,440

(22) Filed: Mar. 23, 2006

(30) Foreign Application Priority Data
Apr. 11, 2005 (JP) 2005-113321
Apr. 11, 2005 (JP) 2005-113322

(51) Int. Cl. B60T 7/12

(52) U.S. Cl. 701/96; 340/903

(57) ABSTRACT

In a vehicular travel control system, when tracking control for a preceding vehicle is being carried out, if a driver intention detector detects a driver's intention to decelerate, a travel path width detector of an external conditions detector detects a decrease in the width of a subject vehicle travel path, and a cutting-in vehicle detector detects a cutting-in vehicle, a control target value corrector increases a set inter-vehicle distance for the tracking control. Thus, it becomes possible to carry out vehicle control that reflects the driver's wish to let a cutting-in vehicle cut in smoothly by increasing the inter-vehicle distance from the preceding vehicle. On the other hand, if the cutting-in vehicle detector does not detect a cutting-in vehicle, the set vehicle speed of the constant speed travel control is decreased, so that it becomes possible to carry out vehicle control that reflects the driver's wish to drive safely when the width of the road in front has decreased.

### RELATED APPLICATION

The present application claims priority to Japanese priority application Nos. 2005-113321 and 2005-113322 filed on Apr. 11, 2005, which are hereby incorporated in their entirety herein by reference.

### BACKGROUND OF THE INVENTION

1. Field of the Invention

The present invention relates to a vehicular travel control system that controls operation of a subject vehicle speed such that, when there is a preceding vehicle, the subject vehicle will track the preceding vehicle based on a set inter-vehicle distance, and when there is no preceding vehicle, makes the subject vehicle travel at a constant speed based on a set vehicle speed.

2. Description of the Related Art

Japanese Patent Application Laid-open No. 10-338053 discloses an arrangement in which the vehicle speed of a subject vehicle is controlled in order to maintain an inter-vehicle distance from a preceding vehicle at a set inter-vehicle distance, and when there is a cutting-in vehicle that cuts in between the subject vehicle and the preceding vehicle, a driver state detection sensor measures a mental state of the driver due to the cutting-in occurring, and the set inter-vehicle distance from the preceding vehicle is corrected according to the driver's mental state.

When tracking control for maintaining a predetermined set inter-vehicle distance from the preceding vehicle is being carried out, if the driver spontaneously carries out a braking operation, tracking control is uniformly stopped in the conventional arrangement. However, there is a possibility that if tracking control is continued in a different form according to the conditions around the vehicle, a more appropriate vehicle control that reflects the psychology of the driver can be carried out.

Furthermore, Japanese Patent Application Laid-open No. 2000-142168 discloses an arrangement in which, if the driver depresses an accelerator pedal and the vehicle travels at a substantially constant vehicle speed for a predetermined time after constant speed travel control for making a vehicle travel at a set vehicle speed is suspended, a set vehicle speed is automatically changed to the above-mentioned constant vehicle speed when constant speed travel control is started again.

When tracking control for maintaining a predetermined set inter-vehicle distance from a preceding vehicle is being carried out, if the driver carries out an acceleration operation by depressing the accelerator pedal, this is because the driver has the intention of decreasing the set inter-vehicle distance of the tracking control or the intention of tracking an accelerating preceding vehicle without being left behind. In such a case, if the set inter-vehicle distance of tracking control or the set vehicle speed of constant speed travel control can be automatically changed without requiring the driver to carry out a switching operation, the operational burden on the driver can be reduced, thus improving the convenience to the vehicle operator.

### SUMMARY OF THE INVENTION

The present invention overcomes the foregoing disadvantages of the prior art by providing a vehicular control system adapted to carry out appropriate vehicle control according to external conditions of a vehicle when a driver's intention to decelerate is detected during vehicle control.

Furthermore, the present invention provides a vehicular control system adapted to carry out appropriate vehicle control according to travel conditions of a preceding vehicle when a driver's intention to accelerate is detected during vehicle control.

According to a first aspect of the present invention, there is provided a vehicular travel control system that controls operation of a subject vehicle such that, when there is a preceding vehicle, the control system makes a subject vehicle track the preceding vehicle based on a set inter-vehicle distance, and that, when there is no preceding vehicle, makes the subject vehicle travel at a constant speed based on a set vehicle speed, wherein the system further comprises a deceleration intention detector that detects a driver's intention to decelerate, external conditions detector that detects external conditions of the subject vehicle, and control target value corrector that, when the deceleration intention detector detects an intention of the driver to decelerate, corrects, based on the external conditions of the subject vehicle detected by the external conditions detector, a control target value for vehicle control.

With this arrangement, when the deceleration intention detector detects the driver's intention to decelerate, the control target value for carrying out tracking control and constant speed travel control is corrected based on the external conditions of the subject vehicle detected by the external conditions detector. Therefore, when the driver's intention to decelerate is detected, it is possible to carry out appropriate tracking control and constant speed travel control according to the external conditions of the subject vehicle rather than uniformly stopping the tracking control and the constant speed travel control.

According to a second aspect of the present invention, in addition to the first aspect, the external conditions detector comprises travel path width detector that detects the width of a subject vehicle travel path, and cutting-in vehicle detector that detects a cutting-in vehicle attempting to cut into the travel path in front of the subject vehicle; and when the deceleration intention detector detects an intention of the driver to decelerate, the travel path width detector detects a decrease in the width of the subject vehicle travel path, and the cutting-in vehicle detector detects a cutting-in vehicle, the control target value corrector increases the set inter-vehicle distance and maintains the set vehicle speed.

With this arrangement, when the deceleration intention detector detects the driver's intention to decelerate, the travel path width detector detects a decrease in the width of the subject vehicle travel path, and the cutting-in vehicle detector detects a cutting-in vehicle, the control system increases the set inter-vehicle distance for the tracking control. Therefore, it is possible to carry out vehicle control so as to reflect the driver's wish to let the cutting-in vehicle cut in smoothly by increasing the inter-vehicle distance from the preceding vehicle.

According to a third aspect of the present invention, in addition to the first aspect, the external conditions detector comprises travel path width detector that detects the width of a subject vehicle travel path, and cutting-in vehicle detector that detects a cutting-in vehicle attempting to cut into the travel path in front of the subject vehicle; and when the deceleration intention detector detects an intention of the driver to decelerate, the travel path width detector detects a decrease in the width of the subject vehicle travel path, and the cutting-in vehicle detector detects no cutting-in vehicle, the control target value corrector maintains the set inter-vehicle distance and decreases the set vehicle speed.

With this arrangement, when the deceleration intention detector detects the driver's intention to decelerate, the travel path width detector detects a decrease in the width of the subject vehicle travel path, and the cutting-in vehicle detector detects no cutting-in vehicle, the set inter-vehicle distance for the tracking control is maintained and the set vehicle speed for the constant speed travel control is decreased. Therefore, it is possible to carry out vehicle control that reflects the driver's wish to drive safely by decreasing the set vehicle speed for the constant speed travel control when the width of the road in front has decreased, for example, after entering an urban road from a highway.

According to a fourth aspect of the present invention, in addition to the second or third aspects, the cutting-in vehicle detector determines as a cutting-in vehicle a vehicle for which the relative lateral distance from the subject vehicle is equal to or greater than a predetermined value and which moves in a direction toward the subject vehicle.

With this arrangement, since a vehicle for which the relative lateral distance from the subject vehicle is equal to or greater than the predetermined value and which is moving in a direction toward the subject vehicle is determined as being a cutting-in vehicle, it is possible to enhance the accuracy with which the cutting-in vehicle is determined.

According to a fifth aspect of the present invention, in addition to the second or third aspects, the cutting-in vehicle detector determines a given vehicle as a cutting-in vehicle based on the relative distance between the subject vehicle and the preceding vehicle and the relative distance between the subject vehicle and the given vehicle.

With this arrangement, since a given vehicle is determined as a cutting-in vehicle based on the relative distance between the subject vehicle and the preceding vehicle and the relative distance between the subject vehicle and the given vehicle, it is possible to carry out determination of a cutting-in vehicle before the given vehicle starts moving laterally.

According to a sixth aspect of the present invention, in addition to the first aspect, the external conditions detector comprises travel path width detector that detects the width of a subject vehicle travel path; and when the deceleration intention detector detects an intention of the driver to decelerate, and the travel path width detector detects a decrease in the width of the subject vehicle travel path, the control target value corrector either increases an allowed degree of deceleration for vehicle deceleration control or advances deceleration start timing for the vehicle deceleration control.

With this arrangement, when the deceleration intention detector detects the driver's intention to decelerate and the travel path width detector detects a decrease in the width of the subject vehicle travel path, either the allowed degree of deceleration for the vehicle deceleration control is increased, or the deceleration start timing for the vehicle deceleration control is advanced. Therefore, it is possible to carry out vehicle control that reflects the driver's wish to drive along a narrow road while being alert to the surroundings when the width of the road in front has decreased, for example, after entering an urban road from a highway.

According to a seventh aspect of the present invention, in addition to the first aspect, the external conditions detector comprises traffic volume detector that detects a traffic volume of a subject vehicle travel path; and when the deceleration intention detector detects an intention of the driver to decelerate, and the traffic volume detector detects that the traffic volume of the subject vehicle travel path is equal to or less than a predetermined value, the control target value corrector increases the set inter-vehicle distance and maintains the set vehicle speed.

With this arrangement, when the deceleration intention detector detects the driver's intention to decelerate and the traffic volume detector detects that the traffic volume of the subject vehicle travel path is equal to or less than the predetermined value, the set inter-vehicle distance for the tracking control is increased. Therefore, it is possible to carry out vehicle control that reflects the driver's intention to drive in a relaxed manner by securing a sufficient inter-vehicle distance from a preceding vehicle when traveling on a road with a low volume of traffic.

According to an eighth aspect of the present invention, in addition to the first aspect, the external conditions detector comprises acceleration/deceleration frequency detector that detects an acceleration/deceleration frequency of the preceding vehicle; and when the deceleration intention detector detects an intention of the driver to decelerate, and the acceleration/deceleration frequency detector detects that the acceleration/deceleration frequency of the preceding vehicle is equal to or greater than a predetermined value, the control target value corrector increases the set inter-vehicle distance and maintains the set vehicle speed.

With this arrangement, when the deceleration intention detector detects the driver's intention to decelerate and the acceleration/deceleration frequency detector detects that the acceleration/deceleration frequency of the preceding vehicle is equal to or greater than the predetermined value, the set inter-vehicle distance for the tracking control is increased. Therefore, it is possible to carry out vehicle control that reflects the driver's intention to avoid unpleasant acceleration/deceleration of the subject vehicle by securing a sufficient inter-vehicle distance when tracking a preceding vehicle that is traveling erratically.

According to a ninth aspect of the present invention, in addition to the first aspect, the external conditions detector comprises visibility distance detector that detects a visibility distance in a direction of travel of the subject vehicle; and when the deceleration intention detector detects an intention of the driver to decelerate, and the visibility distance detector detects that the visibility distance is equal to or less than a predetermined value, the control target value corrector increases the set inter-vehicle distance and decreases the set vehicle speed.

With this arrangement, when the deceleration intention detector detects the driver's intention to decelerate and the visibility distance detector detects that the visibility distance is equal to or less than the predetermined value, the set inter-vehicle distance for the tracking control is increased and the set vehicle speed for the constant speed travel control is decreased. Therefore, it is possible to carry out vehicle control that reflects the driver's intention to drive safely under bad weather conditions such as fog, heavy rain or snowstorm.

According to a tenth aspect of the present invention, in addition to the first aspect, the external conditions detector comprises vehicle width detector that detects a vehicle width of the preceding vehicle; and when the deceleration intention detector detects an intention of the driver to decelerate, and the vehicle width detector detects that the vehicle width of the preceding vehicle is equal to or greater than a predetermined value, the control target value corrector increases the set inter-vehicle distance and maintains the set vehicle speed.

With this arrangement, when the deceleration intention detector detects the driver's intention to decelerate and the vehicle width detector detects that the vehicle width of the preceding vehicle is equal to or greater than the predetermined value, the set inter-vehicle distance for the tracking control is increased. Therefore, it is possible to carry out vehicle control that reflects the driver's intention to secure a wide view of the surroundings by increasing the inter-vehicle distance when tracking a heavy truck, a trailer, etc.

According to an eleventh aspect of the present invention, there is provided a vehicular travel control system that, when there is a preceding vehicle, makes a subject vehicle track the preceding vehicle based on a set inter-vehicle distance, and that, when there is no preceding vehicle, makes the subject vehicle travel at a constant speed based on a set vehicle speed, wherein the system further comprises acceleration intention detector that detects a driver's intention to accelerate, preceding vehicle travel conditions detector that detects travel conditions of the preceding vehicle, and control target value corrector that, when the acceleration intention detector detects an intention of the driver to accelerate, corrects a control target value for vehicle control based on the travel conditions of the preceding vehicle detected by the preceding vehicle travel conditions detector.

With this arrangement, when the acceleration intention detector detects the driver's intention to accelerate, the control target value is corrected based on the travel conditions of the preceding vehicle detected by the preceding vehicle travel conditions detector. Therefore, it is possible to carry out appropriate vehicle control according to the driver's psychology and the travel conditions of the preceding vehicle without requiring the driver to carry out a special switching operation, etc. so as to change the control target value.

According to a twelfth aspect of the present invention, in addition to the eleventh aspect, when a change in speed of the preceding vehicle detected by the preceding vehicle travel conditions detector is equal to or less than a predetermined value while the driver's intention to accelerate is being detected by the acceleration intention detector, the control target value corrector changes the set inter-vehicle distance based on an inter-vehicle distance at the time of completion of acceleration of the subject vehicle.

With this arrangement, while the driver's intention to accelerate is being detected by the acceleration intention detector, if the change in speed of the preceding vehicle detected by the preceding vehicle travel conditions detector is equal to or less than the predetermined value, the set inter-vehicle distance for the tracking control is changed based on the inter-vehicle distance at the time when acceleration of the subject vehicle is completed. Therefore, the acceleration by the driver is recognized as being not for matching the speed of the preceding vehicle but for decreasing the set inter-vehicle distance for the tracking control, so that it is possible to change the set inter-vehicle distance according to the driver's intention without requiring a special switching operation.

According to a thirteenth aspect of the present invention, in addition to the eleventh aspect, when the difference between the acceleration of the subject vehicle and the acceleration of the preceding vehicle detected by the preceding vehicle travel conditions detector is equal to or less than a predetermined value while the driver's intention to accelerate is being detected by the acceleration intention detector, the control target value corrector changes the set vehicle speed based on a vehicle speed at the time of completion of acceleration of the subject vehicle.

With this arrangement, while the driver's intention to accelerate is being detected by the acceleration intention detector, if the difference between the acceleration of the subject vehicle and the acceleration of the preceding vehicle detected by the preceding vehicle travel conditions detector is equal to or less than the predetermined value, the set vehicle speed for the constant speed travel control is changed based on the vehicle speed at the time when acceleration of the subject vehicle is completed. Therefore, the acceleration by the driver is recognized as an intention to track the preceding vehicle, which is moving further away, so that it is possible to change the set vehicle speed according to the driver's intention without requiring a special switching operation.

According to a fourteenth aspect of the present invention, in addition to the eleventh aspect, the system comprises cutting-in vehicle detector that detects a cutting-in vehicle attempting to cut into a travel path in front of the subject vehicle; and when a change in speed of the preceding vehicle detected by the preceding vehicle travel conditions detector is equal to or less than a predetermined value while the driver's intention to accelerate is being detected by the acceleration intention detector, and a cutting-in vehicle is detected by the cutting-in vehicle detector at a frequency that is equal to or greater than a predetermined value before the driver's intention to accelerate is detected by the acceleration intention detector, the control target value corrector changes the set inter-vehicle distance based on an inter-vehicle distance at the time of completion of acceleration of the subject vehicle.

With this arrangement, while the drivers intention to accelerate is being detected by the acceleration intention detector, if the change in speed of the preceding vehicle detected by the preceding vehicle travel conditions detector is equal to or less than the predetermined value, and a cutting-in vehicle is detected by the cutting-in vehicle detector at a frequency that is equal to or greater than the predetermined value before the driver's intention to accelerate is detected, the set inter-vehicle distance for the tracking control is changed based on the inter-vehicle distance at the time when acceleration of the subject vehicle is completed. Therefore, the acceleration by the driver is recognized as an intention to block frequent cutting in front of the subject vehicle, so that it is possible to change the set inter-vehicle distance according to the driver's intention without requiring a special switching operation.

### BRIEF DESCRIPTION OF THE DRAWINGS

FIG. 1 to FIG. 7 show first to sixth embodiments of the present invention; FIG. 1 is a block diagram of a control system for an ACC system, FIG. 2 is a flowchart for explaining the operation of the first embodiment, FIG. 3 is a flowchart for explaining the operation of the second embodiment, FIG. 4 is a flowchart for explaining the operation of the third embodiment, FIG. 5 is a flowchart for explaining the operation of the fourth embodiment, FIG. 6 is a flowchart for explaining the operation of the fifth embodiment, and FIG. 7 is a flowchart for explaining the operation of the sixth embodiment.

FIG. 8 to FIG. 11 show seventh to ninth embodiments of the present invention; FIG. 8 is a block diagram of a control system for an ACC system, FIG. 9 is a flowchart for explaining the operation of the seventh embodiment, FIG. 10 is a flowchart for explaining the operation of the eighth embodiment, and FIG. 11 is a flowchart for explaining the operation of the ninth embodiment.

### DETAILED DESCRIPTION OF THE PREFERRED EMBODIMENT

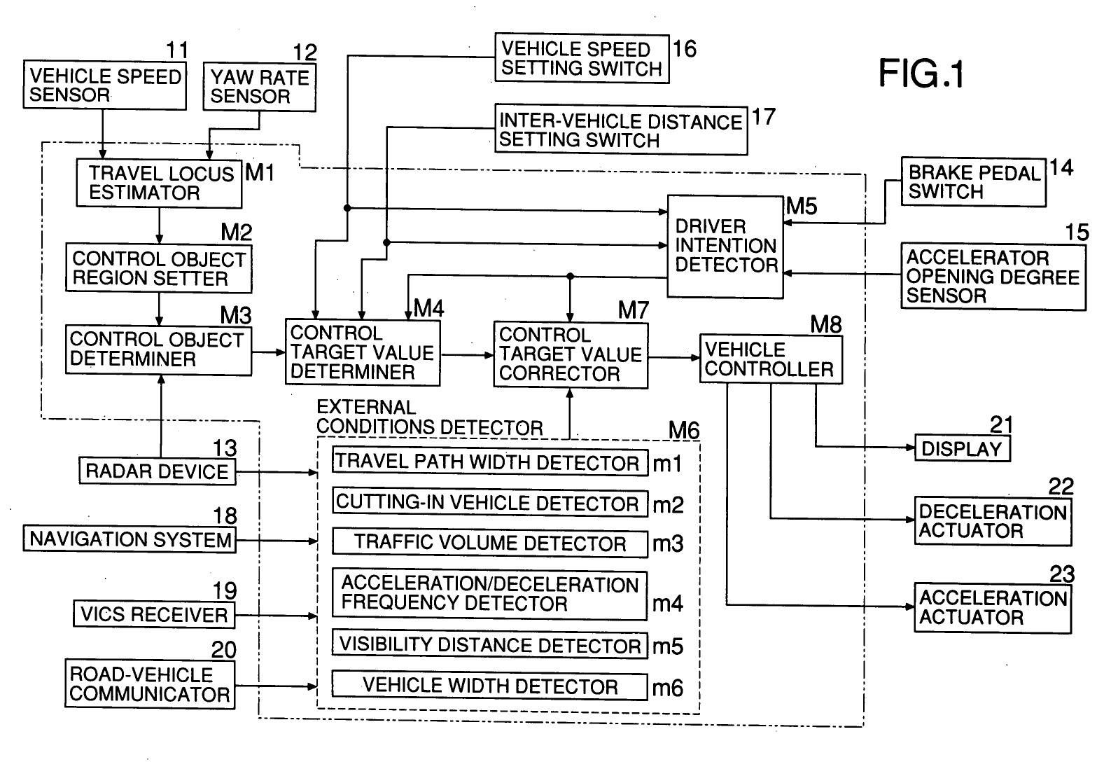

First to sixth embodiments of the present invention are explained below by reference to FIG. 1 to FIG. 7.

As shown in FIG. 1, an ACC (Adaptive Cruise Control) system maintains a preset inter-vehicle distance when there is a preceding vehicle, thus tracking the preceding vehicle, and maintains a preset vehicle speed when there is no preceding vehicle, thus keeping the speed constant. The ACC system includes: travel locus estimator M1; control object region setter M2; control object determiner M3; control target value determiner M4; driver intention detector M5; external conditions detector M6; control target value corrector M7; and vehicle controller M8.

Connected to the travel locus estimator M1 are a vehicle speed sensor 11 and a yaw rate sensor 12. Connected to the control object determiner M3 is a radar device 13. Connected to the driver intention detector M5 are a brake pedal switch 14, a degree of accelerator opening sensor 15, a vehicle speed setting switch 16, and an inter-vehicle distance setting switch 17. Connected to the external conditions detector M6 are the radar device 13, a navigation system 18, VICS receiver 19, and road-vehicle communicator 20. Connected to the vehicle controller M8 are a display 21, a deceleration actuator 22, and an acceleration actuator 23.

The external conditions detector M6 includes: travel path width detector m1; cutting-in vehicle detector m2; traffic volume detector m3; acceleration/deceleration frequency detector m4; visibility distance detector m5; and vehicle width detector m6.

The travel locus estimator M1 estimates a future travel locus of a subject vehicle based on a vehicle speed detected by the vehicle speed sensor 11 and a yaw rate detected by the yaw rate sensor 12. That is, since a turning radius of the subject vehicle can be calculated from a present vehicle speed and yaw rate, the future travel locus of the subject vehicle can be estimated by joining an arc having the turning radius to a present direction of travel of the subject vehicle.

The control object region setter M2 sets a band-shaped control object region on the travel locus estimated by the travel locus estimator M1 so as to have a predetermined width and a predetermined length.

The control object determiner M3 determines whether or not a preceding vehicle detected by the radar device 13 in the control object region set by the control object region setter M2 can become a control object. In this process, if there are a plurality of control object candidates, the preceding vehicle that is the closest to the subject vehicle is determined as the control object, and if there is only one control object candidate, this preceding vehicle is determined as the control object.

The control target value determiner M4 sets a set vehicle speed or a set inter-vehicle distance, which are parameters used for making the subject vehicle track the preceding vehicle determined as the control object or for making the subject vehicle travel at a constant speed, by using an output from the vehicle speed setting switch 16 or an output from the inter-vehicle distance setting switch 17, respectively.

The driver intention detector M5 detects a driver's intention to decelerate using an output from the brake pedal switch 14 or the degree of accelerator opening sensor 15, detects the driver's intention to accelerate using an output from the degree of accelerator opening sensor 15, detects a set vehicle speed for the constant speed travel control intended by the driver using an output from the vehicle speed setting switch 16, and detects a set inter-vehicle distance for the tracking control intended by the driver using an output from the inter-vehicle distance setting switch 17.

The external conditions detector M6 has a plurality of functions: the travel path width detector m1 detects the width of a travel path in front of the subject vehicle using information from the navigation system 18; the cutting-in vehicle detector m2 detects a cutting-in vehicle attempting to cut in front of the subject vehicle using information from the radar device 13; the traffic volume detector m3 detects a traffic volume around the subject vehicle using information from the VICS receiver 19 or the road-vehicle communicator 20; the acceleration/deceleration frequency detector m4 detects a frequency of acceleration or deceleration of a preceding vehicle using information from the radar device 13; the visibility distance detector m5 detects a visibility distance in front of the subject vehicle, which changes due to fog, heavy rain, snowstorm, etc., using information from the radar device 13; and the vehicle width detector m6 detects a vehicle width of a preceding vehicle using information from the radar device 13.

There are two specific determination methods for detecting a cutting-in vehicle by the cutting-in vehicle detector m2. In the first method, a vehicle for which the relative lateral distance from the subject vehicle is equal to or greater than a predetermined value and which moves in a direction toward the subject vehicle is determined as the cutting-in vehicle, thereby enhancing the accuracy of determining the cutting-in vehicle. Furthermore, in the second method, a given vehicle is determined as the cutting-in vehicle based on a relative distance between the subject vehicle and a preceding vehicle and a relative distance between the subject vehicle and the given vehicle, thereby carrying out determination of a cutting-in vehicle at an early stage before the given vehicle starts moving laterally.

The control target value corrector M7 corrects the control target value determined by the control target value determiner M4 according to the external conditions detected by the external conditions detector M6, when the driver intention detector M5 detects the driver's intention to decelerate.

The vehicle controller M8 carries out tracking control or constant speed travel control by driving the deceleration actuator 22 or the acceleration actuator 23, based on the control target value corrected by the control target value corrector M7, so as to open/close a throttle valve or operate a braking system, and informs the driver by displaying a current vehicle control state on the display 23. Therefore, when there is a preceding vehicle that is the control object determined by the control object determiner M3, the subject vehicle tracks the preceding vehicle with a predetermined inter-vehicle distance set by the inter-vehicle distance setting switch 17; and when there is no preceding vehicle that is a control object, the subject vehicle travels at a constant predetermined vehicle speed set by the vehicle speed setting switch 16.

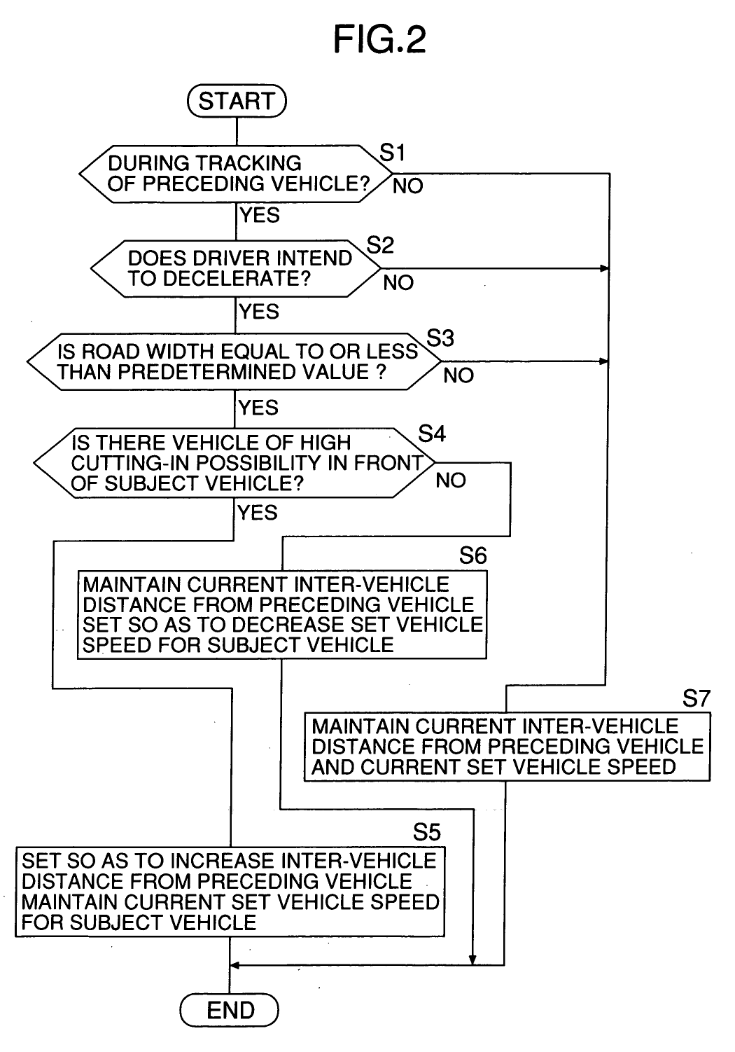

The operation of the first embodiment is now explained by reference to the flowchart of FIG. 2.

Firstly, if in step S1 the subject vehicle tracks a preceding vehicle, in step S2 the driver intention detector M5 detects the driver's intention to decelerate as a result of, for example, the brake pedal switch 14 being switched ON, in step S3 the travel path width detector m1 of the external conditions detector M6 detects a decrease in the width of the travel path in front of the subject vehicle, and in step S4 the cutting-in vehicle detector m2 of the external conditions detector M6 detects a cutting-in vehicle attempting to cut in front of the subject vehicle, then in step S5 the control target value corrector M7 carries out a correction in a direction that increases the set inter-vehicle distance for the tracking control, and maintains a current set vehicle speed for the constant speed travel control. With this operation, it becomes possible to carry out vehicle control that reflects the driver's wish to let a cutting-in vehicle that attempts to cut in front of the subject vehicle smoothly cut in by increasing the inter-vehicle distance from the preceding vehicle.

Furthermore, if in the above step S4 the cutting-in vehicle detector m2 of the external conditions detector M6 detects no cutting-in vehicle attempting to cut in front of the subject vehicle, then in step S6 the control target value corrector M7 maintains the current set inter-vehicle distance, and corrects the set vehicle speed in a direction that decreases it. With this operation, it becomes possible to carry out vehicle control that reflects the driver's wish to drive safely by decreasing the set vehicle speed for the constant speed travel control when the width of the road in front has decreased, for example, after entering an urban road from a highway.

If in the above step S1 tracking of the preceding vehicle is not taking place, if in the above step S2 the driver's intention to decelerate is not detected, and if in the above step S3 the width of the travel path in front of the subject vehicle is not decreasing, then in step S7 the current set inter-vehicle distance and set vehicle speed are maintained.

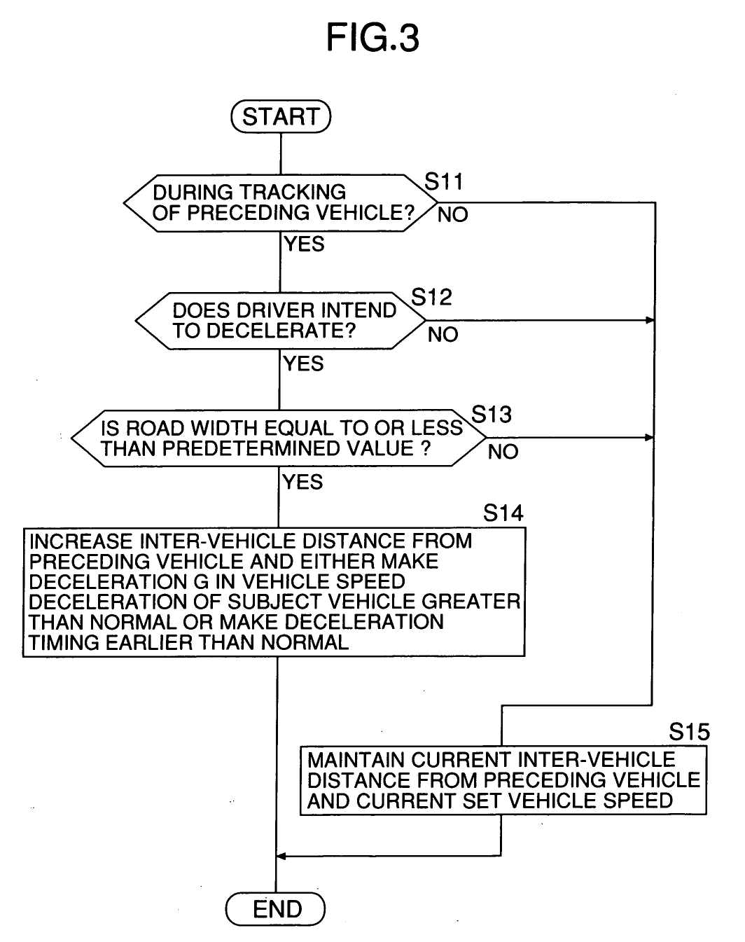

The operation of the second embodiment is now explained by reference to the flowchart of FIG. 3.

Firstly, if in step S11 the subject vehicle is tracking a preceding vehicle, in step S12 the driver intention detector M5 detects a driver's intention to decelerate as a result of, for example, the brake pedal switch 14 being switched ON, and in step S13 the travel path width detector m1 of the external conditions detector M6 detects a decrease in the width of the travel path in front of the subject vehicle, then in step S14 a correction is carried out in a direction that increases the set inter-vehicle distance for the tracking control, and either the deceleration of the subject vehicle by automatic braking is increased compared with that in the normal situation, or the deceleration timing of the subject vehicle is made earlier than that in a normal situation. With this operation, it becomes possible to carry out vehicle control that reflects the driver's wish to drive along a narrow road while being alert to the surroundings when the width of the road in front has decreased, for example, after entering an urban road from a highway.

If in the above step S11 tracking of the preceding vehicle is not taking place, if in the above step S12 the driver's intention to decelerate is not detected, and if in the above step S13 the width of the travel path in front of the subject vehicle is not decreasing, then in step S15 the current set inter-vehicle distance and set vehicle speed are maintained.

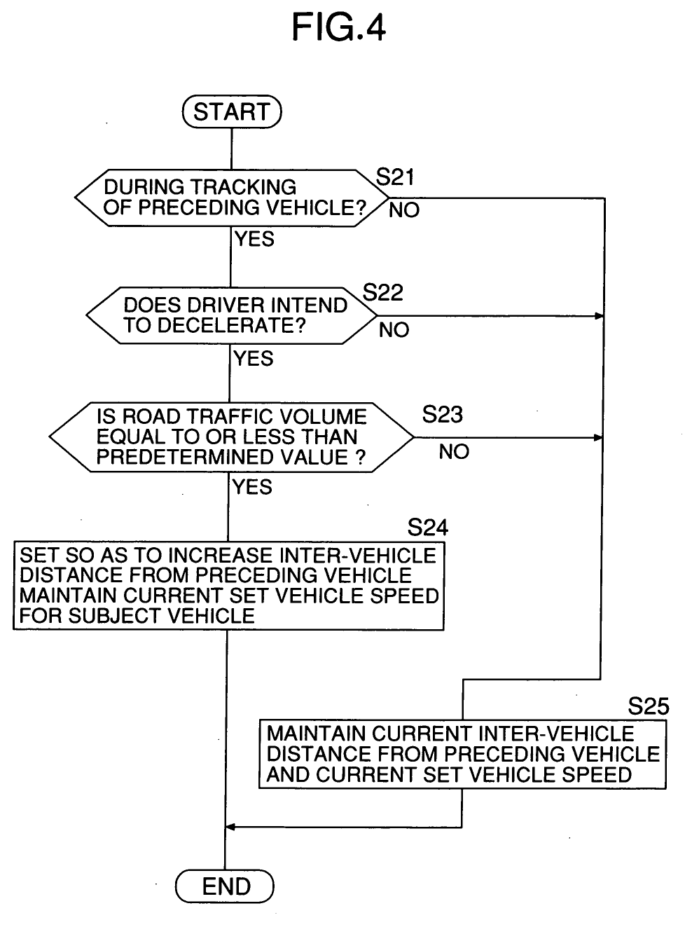

The operation of the third embodiment is now explained by reference to the flowchart of FIG. 4.

Firstly, if in step S21 the subject vehicle is tracking a preceding vehicle, in step S22 the driver intention detector M5 detects the driver's intention to decelerate as a result of, for example, the brake pedal switch 14 being switched ON, and in step S23 the traffic volume detector m3 of the external conditions detector M6 detects that the traffic volume around the subject vehicle is low, then in step S24 a correction is carried out in a direction that increases the set inter-vehicle distance for the tracking control, and the current set vehicle speed for the constant speed travel control is maintained. With this operation, it becomes possible to carry out vehicle control that reflects the driver's wish to drive in a relaxed manner by securing a sufficient inter-vehicle distance from a preceding vehicle when traveling on a road with a low traffic volume.

If in the above step S21 tracking of the preceding vehicle is not taking place, if in the above step S22 the driver's intention to decelerate is not detected, and if in the above step S23 the road traffic volume is not low, then in step S25 the current set inter-vehicle distance and set vehicle speed are maintained.

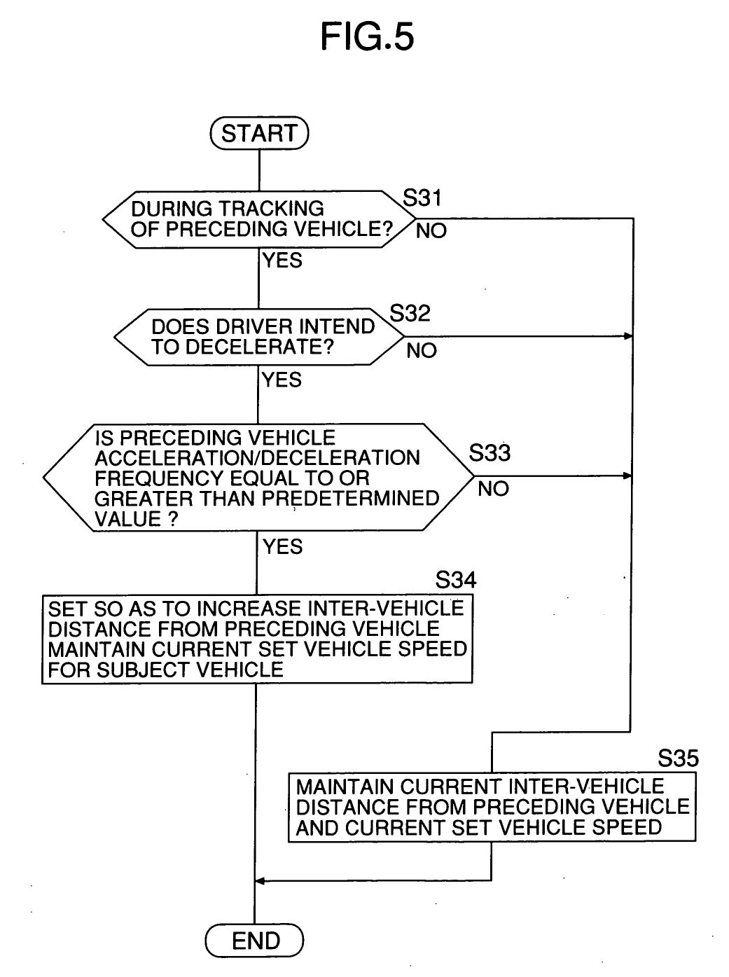

The operation of the fourth embodiment is now explained by reference to the flowchart of FIG. 5.

Firstly, if in step S31 the subject vehicle is tracking a preceding vehicle, in step S32 the driver intention detector M5 detects a driver's intention to decelerate as a result of, for example, the brake pedal switch 14 being switched ON, and in step S33 the acceleration/deceleration frequency detector m4 of the external conditions detector M6 detects that the acceleration/deceleration frequency of the preceding vehicle is equal to or greater than the predetermined value, then in step S34 a correction is carried out in a direction that increases the set inter-vehicle distance for the tracking control, and a current set vehicle speed for the constant speed travel control is maintained. With this operation, it becomes possible to carry out vehicle control that reflects the driver's wish to avoid an unpleasant repetitive acceleration/deceleration of the subject vehicle by securing a sufficient inter-vehicle distance when tracking a preceding vehicle that is traveling erratically.

If in the above step S31 tracking of the preceding vehicle is not taking place, if in the above step S32 the driver's intention to decelerate is not detected, and if in the above step S33 the acceleration/deceleration frequency of the preceding vehicle is less than the predetermined value, then in step S35 the current set inter-vehicle distance and set vehicle speed are maintained.

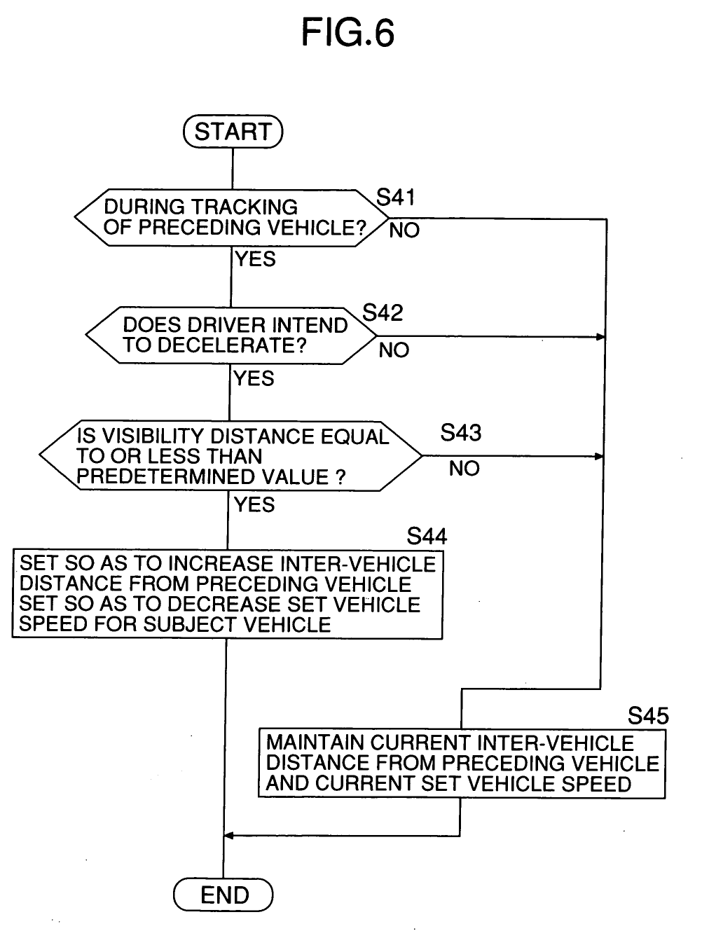

The operation of the fifth embodiment is now explained by reference to the flowchart of FIG. 6.

Firstly, if in step S41 the subject vehicle is tracking a preceding vehicle, in step S42 the driver intention detector M5 detects a driver's intention to decelerate as a result of, for example, the brake pedal switch 14 being switched ON, and in step S43 the visibility distance detector m5 of the external conditions detector M6 detects that the visibility distance in front of the subject vehicle is equal to or less than the predetermined value, then in step S44 a correction is carried out in a direction that increases the set inter-vehicle distance for the tracking control, and a correction is carried out in a direction that decreases the set vehicle speed for the constant speed travel control. With this operation, it becomes possible to carry out vehicle control that reflects the driver's wish to drive safely under bad weather conditions by increasing the set inter-vehicle distance for the tracking control and decreasing the set vehicle speed for the constant speed travel control when the visibility is degraded due to fog, heavy rain, snowstorm, etc.

If in the above step S41 tracking of the preceding vehicle is not taking place, if in the above step S42 the driver's intention to decelerate is not detected, and if in the above step S43 the visibility distance in front of the subject vehicle is greater than the predetermined value, then in step S45 the current set inter-vehicle distance and set vehicle speed are maintained.

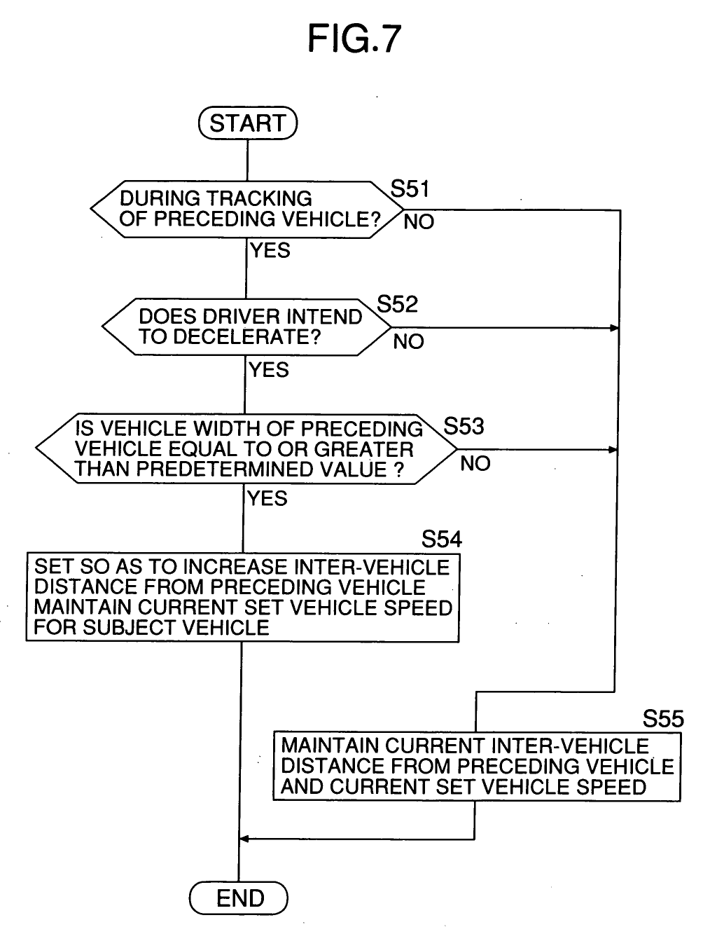

The operation of the sixth embodiment is now explained by reference to the flowchart of FIG. 7.

Firstly, if in step S51 the subject vehicle is tracking a preceding vehicle, in step S52 the driver intention detector M5 detects a driver's intention to decelerate as a result of, for example, the brake pedal switch 14 being switched ON, and in step S53 the vehicle width detector m6 of the external conditions detector M6 detects that the vehicle width of the preceding vehicle is equal to or greater than the predetermined value, then in step S54 a correction is carried out in a direction that increases the set inter-vehicle distance for the tracking control, and the current set vehicle speed for the constant speed travel control is maintained. With this operation, it becomes possible to carry out vehicle control that reflects the driver's wish to ensure that there is a wide view of the surroundings by securing a sufficient inter-vehicle distance from the preceding vehicle when tracking a heavy truck or a trailer.

If in the above step S51 tracking of the preceding vehicle is not tacking place, if in the above step S52 the driver's intention to decelerate is not detected, and if in the above step S53 the vehicle width of the preceding vehicle is less than the predetermined value, then in step S55 the current set inter-vehicle distance and set vehicle speed are maintained.

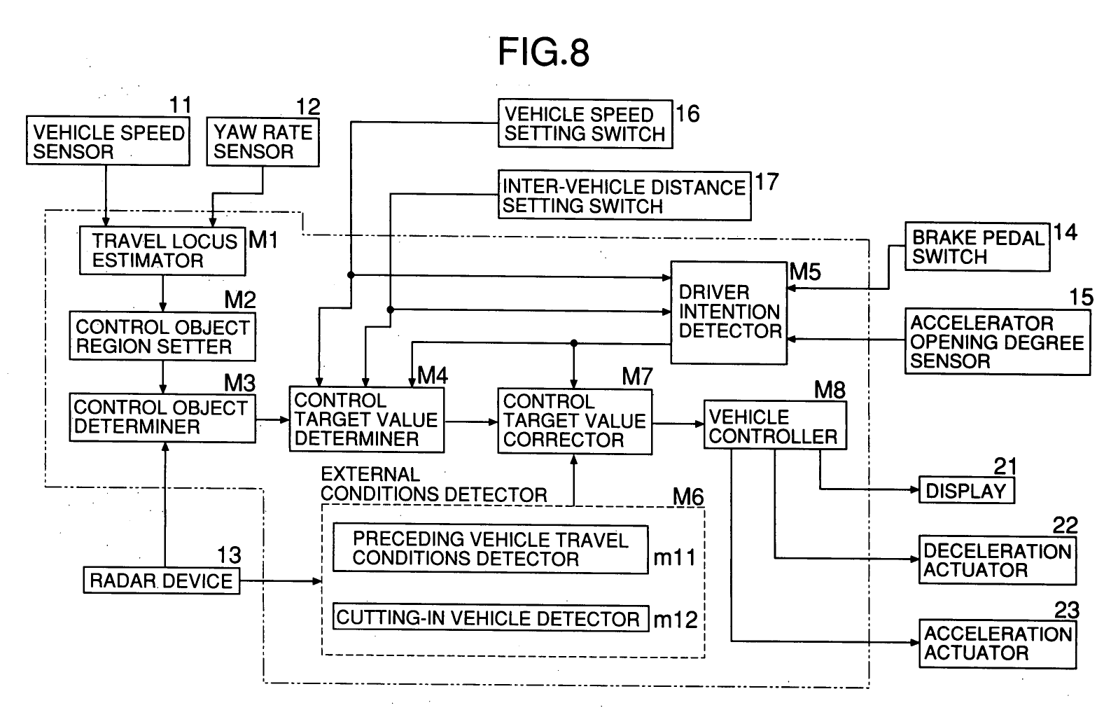

Seventh to ninth embodiments of the present invention are explained below by reference to FIG. 8 to FIG. 11.

As is clear from comparison between FIG. 8 and FIG. 1, the seventh to ninth embodiments are different from the first to sixth embodiment only in terms of the arrangement of external conditions detector M6, and the other arrangements are the same as those of the first to sixth embodiments.

The external conditions detector M6 of the seventh to ninth embodiments includes preceding vehicle travel conditions detector m11 and cutting-in vehicle detector m12. The preceding vehicle travel conditions detector m11 detects a vehicle speed and an acceleration of a preceding vehicle using information from the radar device 13. The cutting-in vehicle detector m12 detects a cutting-in vehicle attempting to cut in front of the subject vehicle using information from the radar device 13. A specific determination method for detecting a cutting-in vehicle by the cutting-in vehicle detector m12 is the same as in the first to sixth embodiments.

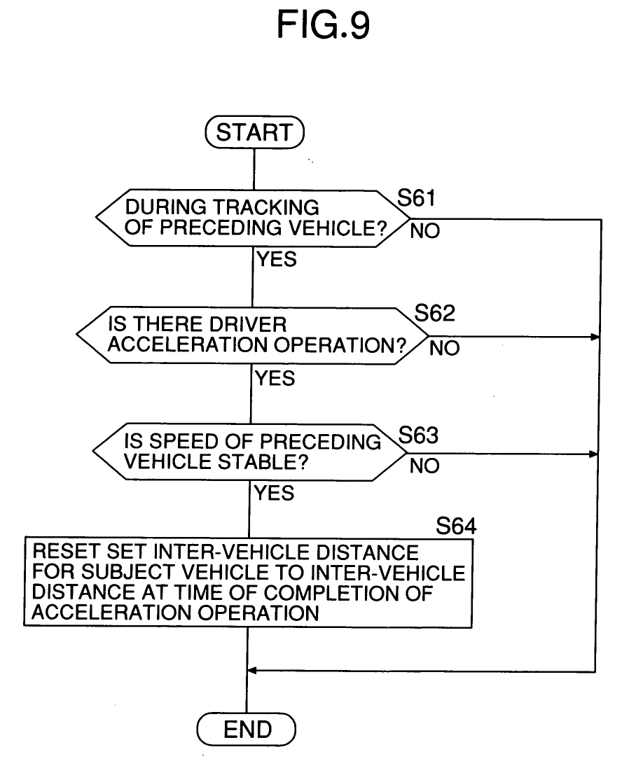

The operation of the seventh embodiment is now explained by reference to the flowchart of FIG. 9.

Firstly, if in step S61 the subject vehicle is tracking a preceding vehicle, in step S62 the driver intention detector M5 detects driver's intention to accelerate using, for example, an output from the degree of accelerator opening sensor 15, and in step S63 the preceding vehicle travel conditions detector m11 of the external conditions detector M6 detects that the speed of the preceding vehicle is stable, then in step S64 the control target value corrector M7 resets the set inter-vehicle distance for the tracking control to an inter-vehicle distance at the time when acceleration of the subject vehicle is completed.

For example, when the subject vehicle is tracking the preceding vehicle at a set vehicle speed of 50 km/h with a set inter-vehicle distance equivalent to a headway of 2.0 sec (time taken for the subject vehicle to reach the current position of the preceding vehicle at the current vehicle speed), and the subject vehicle stops accelerating after accelerating to 70 km/h, if the behavior of the preceding vehicle is stable, then the set inter-vehicle distance is changed from 2.0 sec to, for example, 1.0 sec without changing the set vehicle speed of 50 km/h.

In this way, the above-mentioned acceleration by the driver can be recognized as being carried out not for the purpose of matching the speed of the preceding vehicle but for the purpose of decreasing the set inter-vehicle distance from the preceding vehicle. Therefore, it is possible to change the set inter-vehicle distance according to driver's intention without specially operating the inter-vehicle distance setting switch 17.

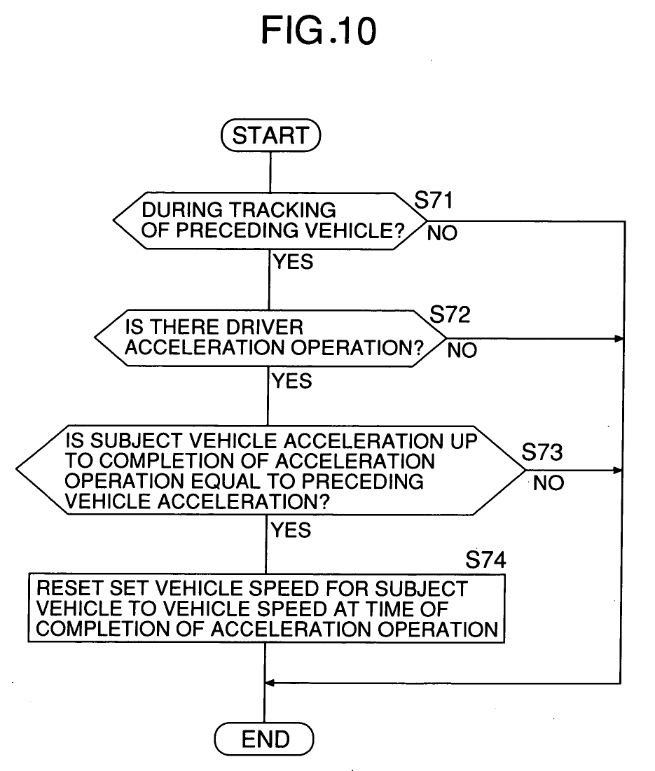

The operation of the eighth embodiment is now explained by reference to the flowchart of FIG. 10.

Firstly, if in step S71 the subject vehicle is tracking a preceding vehicle, in step S72 the driver intention detector M5 detects a driver's intention to accelerate using, for example, an output from the degree of accelerator opening sensor 15, and in step S73 the acceleration of the subject vehicle is equal to the acceleration of the preceding vehicle detected by the preceding vehicle travel conditions detector m11 of the external conditions detector M6, that is, the difference in acceleration between the subject vehicle and the preceding vehicle is equal to or less than a predetermined value, then in step S74 the control target value corrector M7 resets the set vehicle speed for the constant speed travel control to a vehicle speed at the time when acceleration of the subject vehicle is completed. In this case, the set inter-vehicle distance is maintained in the state where it was when acceleration of the subject vehicle started.

For example, when the subject vehicle is tracking the preceding vehicle at a set vehicle speed of 50 km/h with a set inter-vehicle distance of 2.0 sec, and the subject vehicle stops accelerating after accelerating to 70 km/h, if the inter-vehicle distance from the preceding vehicle has not changed from that before starting the acceleration, the set vehicle speed for the constant speed travel control is increased from 50 km/hk to 70 km/h. Therefore, it is possible to track the preceding vehicle at a vehicle speed of 70 km/h without being left behind by the preceding vehicle.

In this way, since the above-mentioned acceleration by the driver is recognized as an intention to track the preceding vehicle, and the set vehicle speed is increased, it is possible to change the set vehicle speed according to the driver's intention without specially operating the vehicle speed setting switch 16.

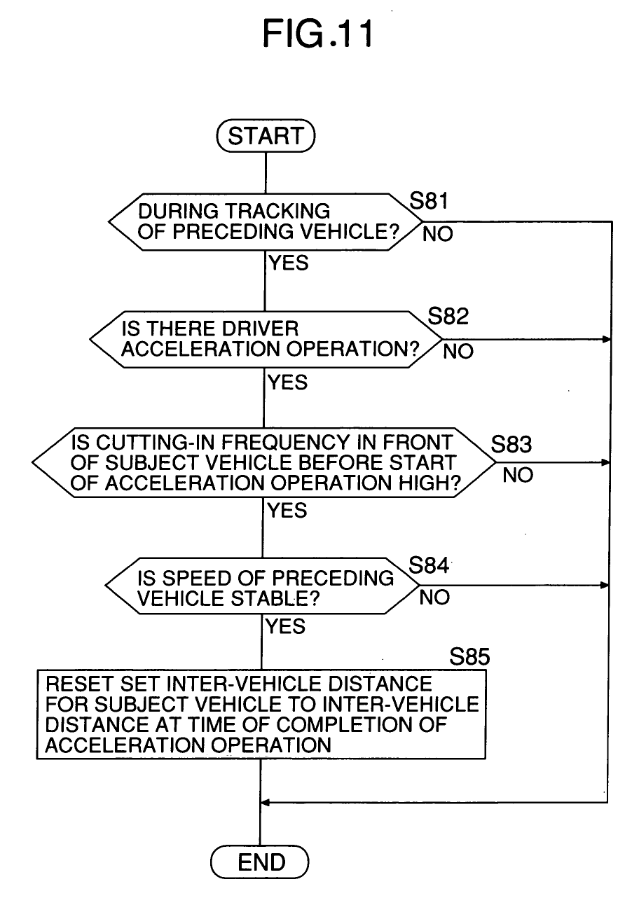

The operation of the ninth embodiment is now explained by reference to the flowchart of FIG. 11.

Firstly, if in step S81 the subject vehicle is tracking a preceding vehicle, in step S82 the driver intention detector M5 detects a driver's intention to accelerate using, for example, an output from the degree of accelerator opening sensor 15, in step S83 the cutting-in vehicle detector m12 detects that the frequency at which other vehicles cut in front of the subject vehicle before it started to accelerate is high, and in step S84 the speed of the preceding vehicle detected by the preceding vehicle travel conditions detector m11 of the external conditions detector M6 is stable, then in step S85 the control target value corrector M7 resets the set inter-vehicle distance for the tracking control to an inter-vehicle distance at the time of completion of the acceleration. In this case, the set inter-vehicle distance is maintained in the state where it was when acceleration of the subject vehicle started.

For example, when the subject vehicle is tracking the preceding vehicle at a set vehicle speed of 50 km/h with a set inter-vehicle distance of 2.0 sec, and the subject vehicle stops accelerating after accelerating to 60 km/h, if the vehicle speed of the preceding vehicle is stable and there were many cutting-in vehicles that cut in between the subject vehicle and the preceding vehicle before starting to accelerate, then the set inter-vehicle distance is changed from 2.0 sec to 1.0 sec, which is the inter-vehicle distance when acceleration was completed, while maintaining a set vehicle speed of 50 km/h.

In this way, since the above-mentioned acceleration by the driver is recognized as an intention to block the frequent cutting-in of other vehicles in front of the subject vehicle, and the set inter-vehicle distance is decreased, it is possible to change the set inter-vehicle distance according to driver's intention without specially operating the inter-vehicle distance setting switch 17.

Embodiments of the present invention have been explained above, but the present invention can be modified in a variety of ways as long as the modifications do not depart from the spirit and scope thereof.

For example, in the embodiments, the driver's intention to decelerate is detected using an output from the brake pedal switch 14, but it may also be detected using an output from the degree of accelerator opening sensor 15, the shift position of a transmission, conversation of occupants, etc.

Furthermore, in the embodiments, the driver's intention to accelerate is detected using an output from the degree of accelerator opening sensor 15, but it may also be detected using the shift position of a transmission, conversation of occupants, etc.

Moreover, in the embodiments, the travel path width detector m1 detects the width of a travel path in front of the subject vehicle using information from the navigation system 18, but it may also be detected using an output from the radar device 13, a camera picture, etc.

Furthermore, in the embodiments, the traffic volume detector m3 detects a traffic volume around the subject vehicle using information from the VICS receiver 19 or the road-vehicle communicator 20, but it may also be detected using an output from the radar device 13, a camera picture, etc.

Moreover, in the embodiments, the acceleration/deceleration frequency detector m4 detects a frequency of acceleration or deceleration of the preceding vehicle using an output from the radar device 13, but it may also be detected using a camera picture, etc.

Furthermore, in the embodiments, the visibility distance detector m5 detects a visibility distance in front of the subject vehicle using an output from the radar device 13, but it may also be detected using a camera picture, the navigation system 18, the VICS receiver 19, the road-vehicle communicator 20, etc.

Moreover, in the embodiments, the vehicle width detector m6 detects the vehicle width of a preceding vehicle using an output from the radar device 13, but it may also be detected using a camera picture, etc.

What is claimed is:

1. A vehicular travel control system comprising a vehicle controller that, when there is a preceding vehicle, makes a subject vehicle track the preceding vehicle based on a set inter-vehicle distance, and that, when there is no preceding vehicle, makes the subject vehicle travel at a constant speed based on a set vehicle speed, wherein the system further comprises a deceleration intention detector that detects a driver's intention to decelerate, an external conditions detector that detects external conditions of the subject vehicle, and a control target value corrector that, when the deceleration intention detector detects an intention of the driver to decelerate, corrects, based on the external conditions of the subject vehicle detected by the external conditions detector, a control target value for vehicle control by the vehicle controller.

2. The vehicular travel control system according to claim 1, wherein the external conditions detector comprises a travel path width detector that detects the width of a subject vehicle travel path, and a cutting-in vehicle detector that detects a cutting-in vehicle attempting to cut into the travel path in front of the subject vehicle; and when the deceleration intention detector detects an intention of the driver to decelerate, the travel path width detector detects a decrease in the width of the subject vehicle travel path, and the cutting-in vehicle detector detects a cutting-in vehicle, the control target value corrector increases the set inter-vehicle distance and maintains the set vehicle speed.

3. The vehicular travel control system according to claim 1, wherein the external conditions detector comprises a travel path width detector that detects the width of a subject vehicle travel path, and a cutting-in vehicle detector that detects a cutting-in vehicle attempting to cut into the travel path in front of the subject vehicle; and when the deceleration intention detector detects an intention of the driver to decelerate, the travel path width detector detects a decrease in the width of the subject vehicle travel path, and the cutting-in vehicle detector detects no cutting-in vehicle, the control target value corrector maintains the set inter-vehicle distance and decreases the set vehicle speed.

4. The vehicular travel control system according to claim 1, further comprising a cutting-in vehicle detector that determines as a cutting-in vehicle a vehicle for which the relative lateral distance from the subject vehicle is equal to or greater than a predetermined value and which moves in a direction toward the subject vehicle.

5. The vehicular travel control system according to claim 1, further comprising a cutting-in vehicle detector that determines a given vehicle as a cutting-in vehicle based on the relative distance between the subject vehicle and the preceding vehicle and the relative distance between the subject vehicle and the given vehicle.

6. The vehicular travel control system according to claim 1, wherein the external conditions detector comprises a travel path width detector that detects the width of a subject vehicle travel path; and when the deceleration intention detector detects an intention of the driver to decelerate, and the travel path width detector detects a decrease in the width of the subject vehicle travel path, the control target value corrector either increases an allowed degree of deceleration for vehicle deceleration control by the vehicle controller or advances deceleration start timing for the vehicle deceleration control.

7. The vehicular travel control system according to claim 1, wherein the external conditions detector comprises a traffic volume detector that detects a traffic volume of a subject vehicle travel path; and when the deceleration intention detector detects an intention of the driver to decelerate, and the traffic volume detector detects that the traffic volume of the subject vehicle travel path is equal to or less than a predetermined value, the control target value corrector increases the set inter-vehicle distance and maintains the set vehicle speed.

8. The vehicular travel control system according to claim 1, wherein the external conditions detector comprises an acceleration/deceleration frequency detector that detects an acceleration/deceleration frequency of the preceding vehicle; and when the deceleration intention detector detects an intention of the driver to decelerate, and the acceleration/deceleration frequency detector detects that the acceleration/deceleration frequency of the preceding vehicle is equal to or greater than a predetermined value, the control target value corrector increases the set inter-vehicle distance and maintains the set vehicle speed.

9. The vehicular travel control system according to claim 1, wherein the external conditions detector comprises a visibility distance detector that detects a visibility distance in a direction of travel of the subject vehicle; and when the deceleration intention detector detects an intention of the driver to decelerate, and the visibility distance detector detects that the visibility distance is equal to or less than a predetermined value, the control target value corrector increases the set inter-vehicle distance and decreases the set vehicle speed.

10. The vehicular travel control system according to claim 1, wherein the external conditions detector comprises vehicle width detector that detects a vehicle width of the preceding vehicle; and when the deceleration intention detector detects an intention of the driver to decelerate, and the vehicle width detector detects that the vehicle width of the preceding vehicle is equal to or greater than a predetermined value, the control target value corrector increases the set inter-vehicle distance and maintains the set vehicle speed.

11. A vehicular travel control system comprising a vehicle controller that, when there is a preceding vehicle, makes a subject vehicle track the preceding vehicle based on a set inter-vehicle distance, and that, when there is no preceding vehicle, makes the subject vehicle travel at a constant speed based on a set vehicle speed, wherein the system further comprises an acceleration intention detector that detects a driver's intention to accelerate, a preceding vehicle travel conditions detector that detects travel conditions of the preceding vehicle, and a control target value corrector that, when the acceleration intention detector detects an intention of the driver to accelerate, corrects a control target value for vehicle control by the vehicle controller based on the travel conditions of the preceding vehicle detected by the preceding vehicle travel conditions detector.

12. The vehicular travel control system according to claim 11, wherein when a change in speed of the preceding vehicle detected by the preceding vehicle travel conditions detector is equal to or less than a predetermined value while the driver's intention to accelerate is being detected by the acceleration intention detector, the control target value corrector changes the set inter-vehicle distance based on an inter-vehicle distance at the time of completion of acceleration of the subject vehicle.

13. The vehicular travel control system according to claim 11, wherein when the difference between the acceleration of the subject vehicle and the acceleration of the preceding vehicle detected by the preceding vehicle travel conditions detector is equal to or less than a predetermined value while the driver's intention to accelerate is being detected by the acceleration intention detector, the control target value corrector changes the set vehicle speed based on a vehicle speed at the time of completion of acceleration of the subject vehicle.

14. The vehicular travel control system according to claim 11, further comprising a cutting-in vehicle detector that detects a cutting-in vehicle attempting to cut into a travel path in front of the subject vehicle; and when a change in speed of the preceding vehicle detected by the preceding vehicle travel conditions detector is equal to or less than a predetermined value while the driver's intention to accelerate is being detected by the acceleration intention detector, and a cutting-in vehicle is detected by the cutting-in vehicle detector at a frequency that is equal to or greater than a predetermined value before the driver's intention to accelerate is detected by the acceleration intention detector, the control target value corrector changes the set inter-vehicle distance based on an inter-vehicle distance at the time of completion of acceleration of the subject vehicle.

15. A method for controlling a subject vehicle to track a preceding vehicle based on a set inter-vehicle distance, and when there is no preceding vehicle, controlling the subject vehicle to travel at a constant speed based on a set vehicle speed, comprising:
detecting a driver's intention to decelerate;
detecting external conditions of the subject vehicle; and
correcting a control target value such that, when an intention of the driver to decelerate is detected, the control target is corrected based on the detected external conditions of the subject vehicle.

16. The method according to claim 15, wherein the detecting external conditions further comprises detecting a width of a subject vehicle travel path, and detecting a cutting-in vehicle attempting to cut into the travel path in front of the subject vehicle; and when an intention of the driver to decelerate is detected, a decrease in the width of the subject vehicle travel path is detected, and a cutting-in vehicle is detected, the control target value is corrected to reflect an increase in the set inter-vehicle distance and maintain the set vehicle speed.

17. The method according to claim 15, wherein the detecting external conditions further comprises detecting a width of a subject vehicle travel path, and detecting a cutting-in vehicle attempting to cut into the travel path in front of the subject vehicle; and when an intention of the driver to decelerate is detected, a decrease in the width of the subject vehicle travel path is detected, and no cutting-in vehicle is detected, the control target value is corrected to maintain the set inter-vehicle distance and decrease the set vehicle speed.

18. The method according to claim 15, further comprising detecting as a cutting-in vehicle a vehicle for which the relative lateral distance from the subject vehicle is equal to or greater than a predetermined value and which moves in a direction toward the subject vehicle.

19. The method according to claim 15, further comprising detecting as a cutting-in vehicle a given vehicle based on the relative distance between the subject vehicle and the preceding vehicle and the relative distance between the subject vehicle and the given vehicle.

20. The method according to claim 15, wherein the detecting external conditions further comprises detecting a width of a subject vehicle travel path; and when an intention of the driver to decelerate is detected, and a decrease in the width of the subject vehicle travel path is detected, the control target value is corrected to either increase an allowed degree of deceleration for vehicle deceleration control or advance deceleration start timing for the vehicle deceleration control.

21. The method according to claim 15, wherein the detecting external conditions further comprises detecting a traffic volume of a subject vehicle travel path; and when an intention of the driver to decelerate is detected, and the detected traffic volume of the subject vehicle travel path is equal to or less than a predetermined value, the control target value is corrected to increase the set inter-vehicle distance and maintain the set vehicle speed.

22. The method according to claim 15, wherein the detecting external conditions further comprises detecting an acceleration/deceleration frequency of the preceding vehicle; and when an intention of the driver to decelerate is detected, and the the acceleration/deceleration frequency of the preceding vehicle is equal to or greater than a predetermined value, the control target value is corrected to increase the set inter-vehicle distance and maintain the set vehicle speed.

23. The method according to claim 15, wherein the detecting external conditions further comprises detecting a visibility distance in a direction of travel of the subject vehicle; and when an intention of the driver to decelerate is detected, and the visibility distance is equal to or less than a predetermined value, the control target value is corrected to increase the set inter-vehicle distance and decrease the set vehicle speed.

24. The method according to claim 15, wherein the detecting external conditions further comprises detecting a vehicle width of the preceding vehicle; and when an intention of the driver to decelerate is detected, and the vehicle width of the preceding vehicle is equal to or greater than a predetermined value, the control target value is corrected to increase the set inter-vehicle distance and maintain the set vehicle speed.

25. A method for controlling a subject vehicle such that, when there is a preceding vehicle, the subject vehicle tracks the preceding vehicle based on a set inter-vehicle distance, and when there is no preceding vehicle, the subject vehicle maintains a constant speed based on a set vehicle speed, comprising:
detecting a driver's intention to accelerate;
detecting travel conditions of the preceding vehicle; and
correcting a control target value such that, when an intention of the driver to accelerate is detected, the control target value is controlled based on the travel conditions of the preceding vehicle.

26. The method according to claim 25, wherein when a change in speed of the preceding vehicle is equal to or less than a predetermined value while the driver's intention to accelerate is detected, the control target value is corrected to change the set inter-vehicle distance based on an inter-vehicle distance at the time of completion of acceleration of the subject vehicle.

27. The method according to claim 25, wherein when the difference between the acceleration of the subject vehicle and the acceleration of the preceding vehicle is equal to or less than a predetermined value while the driver's intention to accelerate is detected, the control target value is corrected to change the set vehicle speed based on a vehicle speed at the time of completion of acceleration of the subject vehicle.

28. The method according to claim 25, further comprising detecting a cutting-in vehicle attempting to cut into a travel path in front of the subject vehicle; and when a change in speed of the preceding vehicle is equal to or less than a predetermined value while the driver's intention to accelerate is detected, and a cutting-in vehicle is detected at a frequency that is equal to or greater than a predetermined value before the driver's intention to accelerate is detected, the control target value is corrected to change the set inter-vehicle distance based on an inter-vehicle distance at the time of completion of acceleration of the subject vehicle.
